(19) United States
(12) Patent Application Publication
(10) Pub. No.: US 2019/0086736 A1
(43) Pub. Date: Mar. 21, 2019

(54) LIQUID CRYSTAL DISPLAY DEVICE

(71) Applicant: SHARP KABUSHIKI KAISHA, Sakai City (JP)

(72) Inventors: KIMIAKI NAKAMURA, Sakai City (JP); MASANOBU MIZUSAKI, Sakai City (JP); TAKASHI KATAYAMA, Sakai City (JP)

(21) Appl. No.: 16/132,821

(22) Filed: Sep. 17, 2018

(30) Foreign Application Priority Data
Sep. 19, 2017 (JP) 2017-179474

(51) Int. Cl. G02F 1/1337; C09K 19/56

(52) U.S. Cl. CPC G02F 1/133711; G02F 2001/133354; C09K 19/56

(57) ABSTRACT

An object is to provide a liquid crystal display device having long-term stability in a pretilt direction.

A liquid crystal display device includes: a pair of substrates; a liquid crystal layer sandwiched between the pair of substrates; alignment films disposed between the liquid crystal layer and the pair of substrates; and polymer layers disposed between the alignment films and the liquid crystal layer. A material for forming the liquid crystal layer is a liquid crystal material. The liquid crystal material contains a liquid crystal compound having a polyphenylene group. A material for forming the alignment film is an alignment film material containing an acrylic resin having a photoreactive functional group. The polymer layer is a polymer of a (meth)acrylate monomer containing an aryl group having no condensed ring structure.

### TECHNICAL FIELD

The present invention relates to a liquid crystal display device.

### BACKGROUND ART

A liquid crystal display device includes a pair of substrates and a liquid crystal layer provided therebetween. In a liquid crystal display device having such a configuration, display is performed by using a change in alignment direction of liquid crystal molecules according to a voltage applied to the liquid crystal layer. An alignment direction (a pretilt direction) of the liquid crystal molecules in a state in which no voltage is applied to the liquid crystal layer has been defined by an alignment film in the related art. Here, a pretilt angle which is an angle between a normal of the alignment film and a director of the liquid crystal molecules is mainly determined according to the combination of the alignment film and a liquid crystal material. The pretilt direction is represented by a pretilt azimuth and a pretilt angle.

It should be noted that the pretilt azimuth refers to a component within a plane of the liquid crystal layer (in a plane of the substrate) in a vector indicating an alignment direction of the liquid crystal molecules within the liquid crystal layer to which no voltage is applied.

In recent years, a polymer sustained alignment technology (hereinafter referred to as a “PSA technology”) has been developed as a technology for controlling the pretilt direction of liquid crystal molecules. The PSA technology is a technology in which a liquid crystal material mixed with a small amount of a polymerizable compound (typically a photopolymerizable monomer) is enclosed in a liquid crystal panel, and then, the monomer is polymerized to form a polymer between a liquid crystal layer and an alignment film, thereby controlling a pretilt direction of liquid crystal molecules.

When the PSA technology is used, an alignment state of the liquid crystal molecules when the polymer is generated is maintained (stored) even after the voltage is removed (in a state in which no voltage is applied). Therefore, the PSA technology has an advantage that the pretilt azimuth and the pretilt angle of liquid crystal molecules can be adjusted by controlling an electric field or the like formed in the liquid crystal layer. Further, since the PSA technology does not require a rubbing treatment, the PSA technology is particularly suitable for forming a vertical alignment type liquid crystal layer in which it is difficult for a pretilt direction to be controlled due to the rubbing treatment.

For example, Patent Document 1 discloses a liquid crystal display device using the PSA technology. In the liquid crystal display device described in Patent Document 1, a nematic liquid crystal material contains a liquid crystalline compound having a terphenyl ring structure as an essential component, and a liquid crystal layer further contains a part of a photopolymerizable compound which is a raw material of a photopolymer.

### PRIOR ART DOCUMENT

### Patent Document

[Patent Document 1] Japanese Patent No. 5476427

### SUMMARY OF THE INVENTION

### Problem to be Solved by the Invention

However, in the liquid crystal display device using the PSA technology of the related art as described in Patent Document 1, long-term stability in a pretilt direction is required according to market demand.

An aspect of the present invention has been made in view of such circumstances, and an object thereof is to provide a liquid crystal display device having long-term stability in a pretilt direction.

### Means for Solving the Problems

To solve the above-described problem, one aspect of the present invention is a liquid crystal display device including: a pair of substrates; a liquid crystal layer sandwiched between the pair of substrates; alignment films disposed between the liquid crystal layer and the pair of substrates; and polymer layers disposed between the alignment films and the liquid crystal layer. A material for forming the liquid crystal layer is a liquid crystal material. The liquid crystal material contains a liquid crystal compound having a polyphenylene group. A material for forming the alignment film is an alignment film material containing an acrylic resin having a photoreactive functional group. The polymer layer is a polymer of a (meth)acrylate monomer containing an aryl group having no condensed ring structure.

In one aspect of the present invention, the liquid crystal compound may contain at least one of a liquid crystal compound (L1) having a terphenyl group and a liquid crystal compound (L2) having a tetraphenyl group.

In one aspect of the present invention, the liquid crystal compound may contain both a liquid crystal compound (L1) having a terphenyl group and a liquid crystal compound (L2) having a tetraphenyl group.

In one aspect of the present invention, a total content of the liquid crystal compound (L1) and the liquid crystal compound (L2) relative to a total mass of the liquid crystal material may be 3% by mass or more and 15% by mass or less.

In one aspect of the present invention, the polymer layer may be a polymer of a di(meth)acrylate monomer having a 4,4′-biphenylene group.

In one aspect of the present invention, the alignment film material may contain inorganic compound particles expressed by a general equation SiOₓ—AlOₓ (x is an integer from 1 to 12), and a content of the inorganic compound particles relative to a total mass of the acrylic resin may be greater than 0% by mass and smaller than 7% by mass.

In one aspect of the present invention, the inorganic compound particles may be expressed by a general equation SiO₄—AlO₄.

### Effect of the Invention

According to one aspect of the present invention, a liquid crystal display device having long-term stability in a pretilt direction is provided.

### BRIEF DESCRIPTION OF THE DRAWINGS

FIG. 1 is a cross-sectional view schematically showing a liquid crystal display device of an embodiment.

### EMBODIMENTS FOR CARRYING OUT THE INVENTION

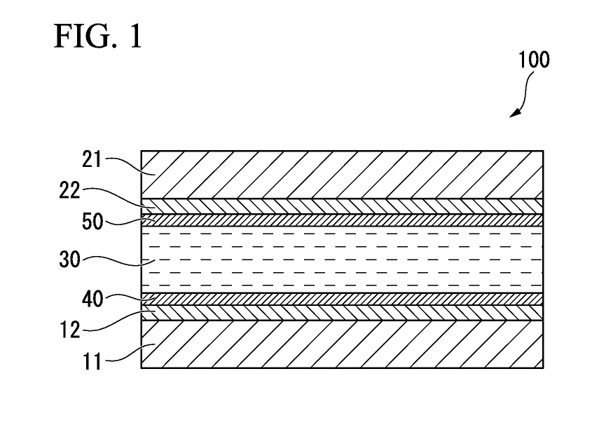

Hereinafter, an embodiment of the present invention will be described with reference to FIG. 1. It should be noted that in FIG. 1, dimensions, proportions, and the like of respective components have been appropriately varied in order for ease of viewing.

### <Liquid Crystal Display Device>

FIG. 1 is a cross-sectional view schematically illustrating a liquid crystal display device of an embodiment. As illustrated in FIG. 1, a liquid crystal display device 100 of the embodiment includes one substrate 11, the other substrate 21, a liquid crystal layer 30 sandwiched between one substrate 11 and the other substrate 21, a first alignment film 12 disposed between the liquid crystal layer 30 and the one substrate 11, a second alignment film 22 disposed between the liquid crystal layer 30 and the other substrate 21, a first polymer layer 40 disposed between the first alignment film 12 and the liquid crystal layer 30, and a second polymer layer 50 disposed between the second alignment film 22 and the liquid crystal layer 30.

It should be noted that one substrate 11 and the other substrate 21 correspond to “a pair of substrates” in the claims. Further, the first alignment film 12 and the second alignment film 22 correspond to “alignment films” in the claims. Further, the first polymer layer 40 and the second polymer layer 50 correspond to “polymer layers” in the claims. In the embodiment, the “polymer layer” means both the first polymer layer 40 and the second polymer layer 50.

The liquid crystal display device 100 of the embodiment is applied to a liquid crystal display device using an optically compensated bend (OCB) scheme and a vertical alignment (VA) scheme.

### [One Substrate]

The one substrate 11 illustrated in FIG. 1 is a TFT substrate. The one substrate 11 includes a driving TFT element. A drain electrode, a gate electrode, and a source electrode of the driving TFT element are electrically connected to a pixel electrode, a gate bus line, and a source bus line, respectively. Pixels are electrically connected via electric wirings of a source bus line and a gate bus line.

A known material can be used as a material for forming each member of the one substrate 11. It is preferable for IGZO (quaternary mixed crystal semiconductor material containing indium (In), gallium (Ga), zinc (Zn), and oxygen (O)) to be used as a material of a semiconductor layer of the driving TFT included in the one substrate 11. When IGZO is used as a material for forming a semiconductor layer, leakage of charge is suppressed since an off-leakage current is small in the obtained semiconductor layer. Accordingly, it is possible to lengthen a pause period after a voltage is applied to the liquid crystal layer 30. As a result, it is possible to reduce the number of times of voltage application during a period in which an image is displayed, and to reduce power consumption of the liquid crystal display device 100.

For the one substrate 11, an active matrix scheme in which a driving TFT is included in each pixel may be used, or a simple matrix scheme in which each pixel does not include a driving TFT may be used.

### [First Alignment Film]

The first alignment film 12 has a function of giving an alignment regulation force to the liquid crystal layer 30 that is in contact with a surface thereof. The first alignment film 12 is a photoalignment film that gives a pretilt angle to the liquid crystal layer 30. In the photoalignment film, a material for forming the alignment film has a photoreactive functional group, and the photoalignment film gives the alignment regulation force through light irradiation.

A material for forming the first alignment film 12 is an alignment film material containing an acrylic resin having a photoreactive functional group. Accordingly, the first alignment film 12 can give a pretilt angle greater than 0° to the liquid crystal layer 30.

The photoreactive functional group is preferably at least one selected from a group consisting of an azobenzene group, a cinnamate group, a coumarin group, and a chalcone group, and more preferably, at least one of the azobenzene group and the chalcone group.

An acrylic resin having the azobenzene group as the photoreactive functional group is exemplified in Equations (a1) and (a2) below.

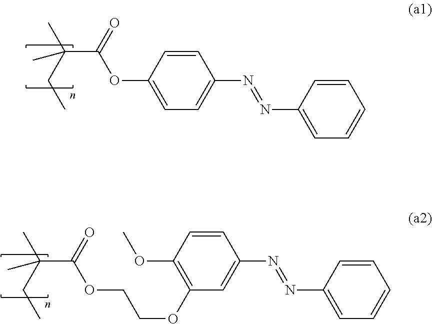

(where, n indicates a degree of polymerization)

An acrylic resin having the cinnamate group as a photoreactive functional group is exemplified in Equations (b1) to (b6) below.

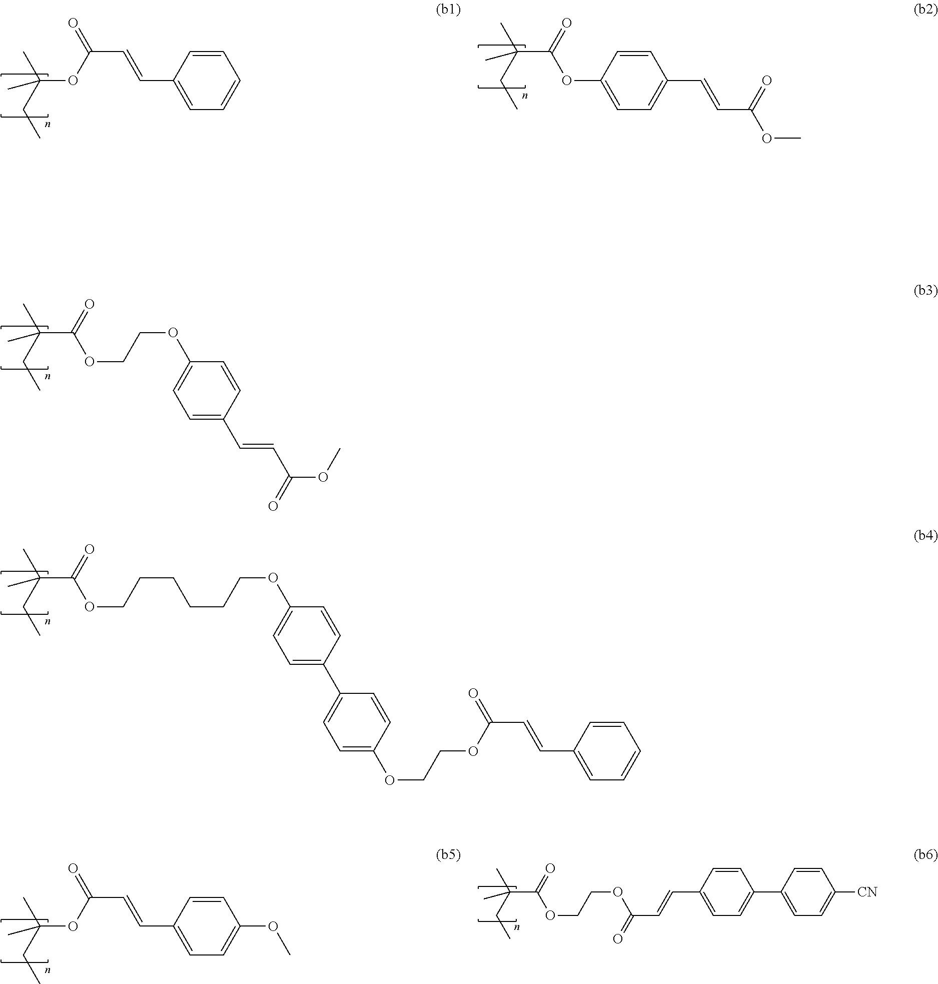

(where, n has the same meaning as described above)

An acrylic resin having the coumarin group as the photoreactive functional group is exemplified in Equation (c1) below.

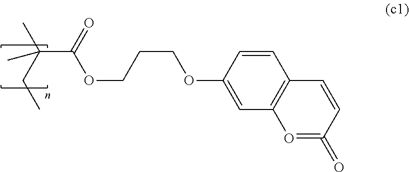

(where, n has the same meaning as described above)

An acrylic resin having a chalcone group as a photoreactive functional group is exemplified in Equations (d1) and (d2) below.

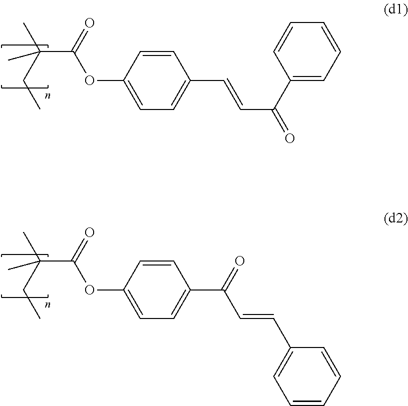

(where, n has the same meaning as described above)

### (Inorganic Compound Particles)

It is preferable for the above-described alignment film material to further contain inorganic compound particles. The inorganic compound particles contained in the alignment film material are, for example, a compound expressed by a general equation SiOₓ—AlOₓ. In the above equation, x is an integer of 1 to 12.

By the first alignment film 12 including the inorganic compound particles, thermal stability of the first alignment film 12 is improved. A reason for the improved thermal stability of the first alignment film 12 has been discussed using the following model.

The acrylic resin includes a plurality of highly flexible molecular chains. The arrangement of the molecular chains in such an acrylic resin tends to be disturbed in a high temperature state. As a result, the thermal stability of an alignment film of the related art can be considered to become degraded. On the other hand, in the first alignment film 12 of this embodiment, although the molecular chains of the acrylic resin move, the disturbance of the arrangement of the molecular chains can be suppressed by the inorganic compound particles serving as a fulcrum. Therefore, the thermal stability of the first alignment film 12 can be considered to be improved.

In the inorganic compound particles expressed by the general equation SiOₓ—AlOₓ, an influence on reliability of the liquid crystal display device 100 can be reduced since SiOₓ and AlOₓ themselves are nonionic.

Further, the inorganic compound particles expressed by the general equation SiOₓ—AlOₓ have a substantially spherical structure having voids therein. Accordingly, SiOₓ—AlOₓ is easily uniformly dispersed within a plane of the first alignment film 12. Accordingly, the thermal stability within the plane of the first alignment film 12 can be made uniform.

A particle diameter of SiOₓ—AlOₓ is preferably 0.05 μm or more and 0.2 μm or less. When the particle diameter of SiOₓ—AlOₓ is 0.05 μm or more, SiOₓ—AlOₓ is easily uniformly dispersed in the first alignment film 12. As a result, the thermal stability within the plane of the first alignment film 12 can be made uniform and can be improved. Further, when the particle diameter of SiOₓ—AlOₓ is 0.2 μm or less, the thickness of the first alignment film 12 can be controlled such that the thickness becomes uniform. When the particle diameter of SiOₓ—AlOₓ is 0.2 μm or less, burn-in due to charge accumulation (burn-in due to a residual DC mode) can be reduced.

In the present specification, for the particle diameter of SiOₓ—AlOₓ, a value obtained by measuring a dispersion solution obtained by dispersing SiOₓ—AlOₓ in a highly polar solvent using a dynamic light scattering method is adopted. For the highly polar solvent, an alcohol type solvent such as ethanol may be used. A concentration of SiOₓ—AlOₓ is adjusted to be within a range of 0.01 to 5% by mass with respect to a total amount of the dispersion solution.

Further, AlOₓ exhibits slightly hydrophilic characteristics. From these facts, in the inorganic compound particles expressed by a general equation SiOₓ—AlOₓ, water or a hydrophilic compound can be captured into a substantially spherical structure thereof. An effect of improvement of moisture resistance of the liquid crystal display device 100 can thereby be obtained.

In particular, the inorganic compound particles contained in the first alignment film 12 are preferably SiO₄—AlO₄.

A content of the inorganic compound particles with respect to a total mass of the acrylic resin is preferably more than 0% by mass and, more preferably, 1% by mass or more. Further, the content of the inorganic compound particles with respect to the total mass of the acrylic resin is preferably less than 7% by mass and, more preferably, 5% by mass or less.

When the content of the inorganic compound particles is more than 0% by mass, an effect of improvement of thermal stability can be obtained. On the other hand, when the content of the inorganic compound particles is less than 7% by mass, a first alignment film 12 having high transparency can be obtained.

The first alignment film 12 can be obtained by adding the inorganic compound particles to the alignment film material containing an acrylic resin and forming a film. Since SiOₓ—AlOₓ which is the inorganic compound particles is an oxide, SiOₓ—AlOₓ interacts with an unshared electron pair of oxygen atoms in the acrylic resin. Accordingly, the inorganic compound particles can be uniformly dispersed in a film of which the forming material is an acrylic resin.

### [Liquid Crystal Layer]

A material for forming the liquid crystal layer 30 is a liquid crystal material. It is preferable for the liquid crystal material to contain a liquid crystal compound having a polyphenylene group. It is preferable for the liquid crystal compound having the polyphenylene group to contain at least one of a liquid crystal compound having a terphenyl group and a liquid crystal compound having a tetraphenyl group. The liquid crystal compound having the terphenyl group is expressed by Equation (L1). The liquid crystal compound having the tetraphenyl group is expressed by Equation (L2).

In the present specification, the liquid crystal compound having the terphenyl group may be referred to as a “liquid crystal compound (L1)”. The liquid crystal compound having the tetraphenyl group may be referred to as a “liquid crystal compound (L2)”.

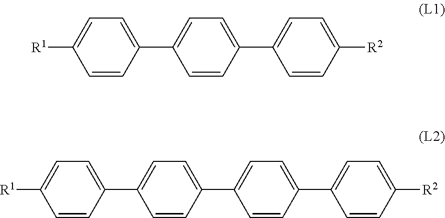

[where, R¹ and R² independently indicate a linear alkyl group having 0 to 6 carbon atoms, further, one or more hydrogen atoms bonded to the aromatic ring may be independently substituted with halogen atoms]

The linear alkyl group indicated by R¹ and R² is preferably an ethyl group, a propyl group, or a butyl group.

Examples of the halogen atom which may substitute one or more hydrogen atoms bonded to the aromatic ring may include a fluorine atom, a chlorine atom, a bromine atom, and an iodine atom. The fluorine atom is preferable.

When the liquid crystal display device of the embodiment is used as an OCB type liquid crystal display device, it is preferable for the liquid crystal compound having the polyphenylene group to contain both the liquid crystal compound (L1) and the liquid crystal compound (L2). A liquid crystal material containing the liquid crystal compound (L1) has low rotational viscosity. Therefore, in the resultant liquid crystal display device, it tends to be difficult for a reduction in a response speed due to an increase in the rotational viscosity to occur. In addition, the liquid crystal compound (L1) tends to have high low-temperature stability due to an increase in rotational viscosity. On the other hand, the liquid crystal compound (L2) tends to have a high Δn. Therefore, by using both of the liquid crystal compound (L1) and the liquid crystal compound (L2) in combination, Δn of the liquid crystal material is high and high-speed response of the liquid crystal display device can be realized.

A total content of the liquid crystal compound (L1) and the liquid crystal compound (L2) with respect to a total mass of the liquid crystal material is 3% by mass or more and 15% by mass or less. When the total content of the liquid crystal compound (L1) and the liquid crystal compound (L2) is 3% by mass or more, a liquid crystal material having a sufficiently high Δn can be obtained. When a liquid crystal material having a sufficiently high Δn is used, a thickness of the liquid crystal cell can be reduced. A liquid crystal display device using such a liquid crystal cell can be suitably applied to, particularly, an OCB type liquid crystal display device.

On the other hand, when the total content of the liquid crystal compound (L1) and the liquid crystal compound (L2) is 15% by mass or less, the rotational viscosity of the liquid crystal material does not become too high, and it is easy for a response speed of the obtained liquid crystal display device to be maintained in a high state.

The total content of the liquid crystal compound (L1) and the liquid crystal compound (L2) with respect to the total mass of the liquid crystal material is more preferably 5% by mass or more. Further, the total content of the liquid crystal compound (L1) and the liquid crystal compound (L2) with respect to the total mass of the liquid crystal material is preferably 15% by mass or less and, more preferably, 12% by mass or less.

A ratio of the content of the liquid crystal compound (L1) to the liquid crystal compound (L2) is preferably L1:L2=2:1 to 50:1 and, more preferably, 10:1 to 30:1 in terms of a mass ratio. When the ratio of the content of the liquid crystal compound (L1) to the liquid crystal compound (L2) is in the above range, the rotational viscosity of the liquid crystal material does not become too high, and it is easy for the response speed of the obtained liquid crystal display device to be maintained in a high state.

For the liquid crystal material, a negative type liquid crystal material having negative dielectric anisotropy may be used or a positive type liquid crystal material having positive dielectric anisotropy may be used.

An example of the positive type liquid crystal material having positive dielectric anisotropy may include a mixture of a polar liquid crystal compound having positive dielectric anisotropy and a nonpolar liquid crystal compound. Examples of the polar liquid crystal compound having positive dielectric anisotropy include the following compounds.

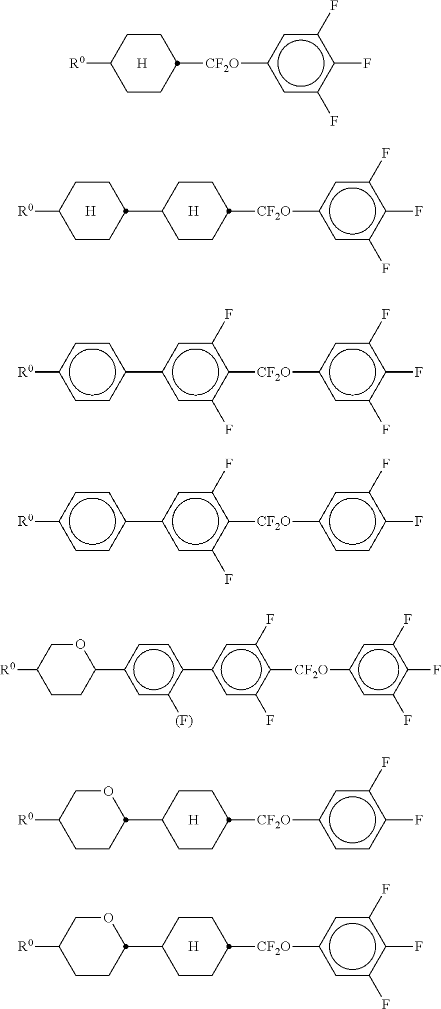

(where, R⁰ indicates a saturated alkyl group having 1 to 12 carbon atoms)

Examples of the negative type liquid crystal material having negative dielectric anisotropy may include a mixture of a polar liquid crystal compound having negative dielectric anisotropy and a nonpolar liquid crystal compound. Examples of a polar liquid crystal compound having negative dielectric anisotropy include the following compounds.

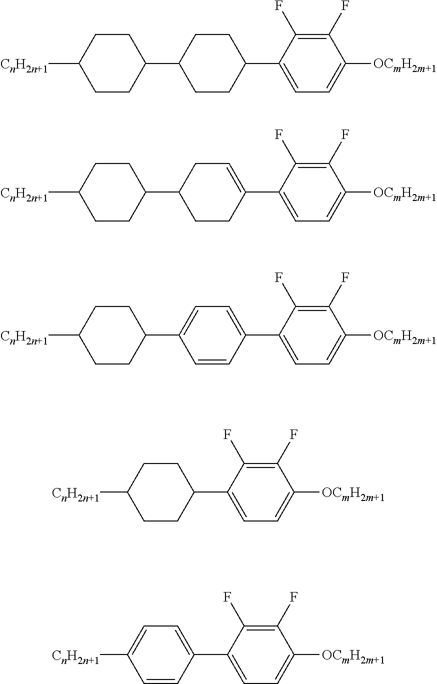

(where, n and m are integers from 1 to 18)

The nonpolar liquid crystal compounds are the same for positive type liquid crystal materials and negative type liquid crystal materials, and examples thereof may include the following compounds.

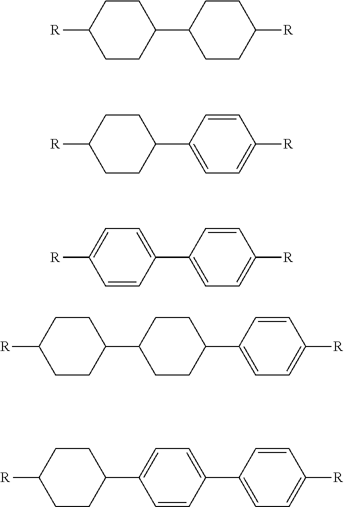

(where, R indicates a linear alkyl group having 1 to 8 carbon atoms)

### [Polymer Layer]

The liquid crystal display device 100 of the embodiment includes the polymer layer in order to set the pretilt angle to 10° or more. In a liquid crystal display device of the related art, in order to obtain a polymer layer, a photopolymerizable monomer is included in a liquid crystal material, and ultraviolet light is radiated from one substrate to photopolymerize the monomer, as will be described in detail below. When a liquid crystal compound (L1) having a terphenyl group and a liquid crystal compound (L2) having a tetraphenyl group are included in the liquid crystal material in order to obtain a liquid crystal display device using an OCB scheme, thicknesses of the polymer layers may be different between the two substrates. Accordingly, the pretilt angle is different between the substrates, and the stability of the pretilt alignment of the liquid crystal molecules may be degraded.

This is considered to be because the liquid crystal compound (L1) and the liquid crystal compound (L2) in the liquid crystal material absorb ultraviolet light, and accordingly, a difference in the amount of light irradiation between a light irradiation surface and the side opposite to the light irradiation surface becomes great. Accordingly, monomers present near the side opposite to the light irradiation surface move in the liquid crystal material toward the light irradiation surface, and many monomers are consumed on the light irradiation surface side as compared with the side opposite to the light irradiation surface. As a result, the thickness of the polymer layer is considered to be greater on the light irradiation surface side than on the side opposite to the light irradiation surface.

It has been found from results of intensive research of the inventors that the above problem can be solved by using a monomer having a high affinity with the acrylic resin which is a material for forming the alignment films provided on surfaces on the liquid crystal layer sides of both the substrates. That is, it has been seen that movement of monomers can also be suppressed in the liquid crystal material and a difference in the amount of monomer consumption between the light irradiation surface side and the side opposite to the light irradiation surface can be reduced by using a monomer having a high affinity with the alignment films containing the acrylic resin. As a result, it has been seen that a difference in thickness of the polymer layer between the light irradiation surface side and the side opposite to the light irradiation surface can be reduced.

In the embodiment, a (meth)acrylate monomer containing an aryl group having no condensed ring structure is used as the monomer having a high affinity with the acrylic resin. The monomer has a high affinity with the acrylic resin due to having a (meth)acryl group. Further, solubility in the liquid crystal material is high due to having an aryl group. A resultant polymer becomes rigid, which contributes to improvement of the stability of the pretilt angle due to having an aryl group. Further, in an aryl group having no condensed ring structure, there is less conjugation and it is difficult for ultraviolet light to be absorbed, as compared with an aryl group having a condensed ring structure. Therefore, a difference in the amount of light irradiation between the light irradiation surface side and the side opposite to the light irradiation surface is reduced by including an aryl group having no condensed ring structure. Accordingly, it is possible to reduce the difference in the amount of monomer consumption between the light irradiation surface side and the side opposite to the light irradiation surface.

Examples of the aryl group having no condensed ring structure include a 1,4-phenylene group and a 4,4′-biphenylene group.

It is preferable for a di(meth)acrylate monomer having a 4,4′-biphenylene group to be used as the monomer. The first polymer layer 40 and the second polymer layer 50 may be polymers of a di(meth)acrylate monomer having a 4,4′-biphenylene group. It should be noted that, in the present invention, “(meth)acrylate monomer” refers to both an acrylate monomer and a methacrylate monomer.

The di(meth)acrylate monomer having a 4,4′-biphenylene group may be expressed by general equations (1) or (2) below.

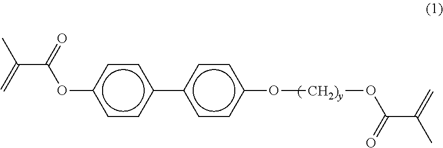

(in Equation (1), y is an integer from 0 to 6)

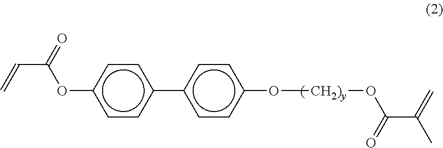

(in Equation (2), y is the same as above)

The hydrogen atoms in the 4,4′-biphenylene groups in Equations (1) and (2) may be independently substituted with a halogen atom, a methyl group, an ethyl group, a methoxy group, or an ethoxy group.

When y in Equations (1) and (2) is equal to or greater than 0, the affinity with the first alignment film 12 and the second alignment film 22 is increased. On the other hand, when y is equal to or smaller than 6, flexibility does not become too high and the thermal stability can be maintained in a high state. When the thermal stability is high, the stability (reliability) of the pretilt angle is improved.

### [Another Substrate]

The other substrate 21 illustrated in FIG. 1 is a color filter substrate. The other substrate 21 includes, for example, a red color filter layer that absorbs a part of incident light and transmits red light, a green color filter layer that absorbs a part of the incident light and transmits green light, and a blue color filter layer that absorbs a part of the incident light and transmits blue light.

Further, the other substrate 21 may include an overcoat layer that covers the surface for the purpose of preventing the substrate surface from being flattened and coloring material components from the color filter layer from being eluted.

### [Second Alignment Film]

The second alignment film 22 has a function of giving an alignment regulation force to the liquid crystal layer 30 that is in contact with the surface, similar to the first alignment film 12. The second alignment film 22 is a photoalignment film that gives a pretilt angle to the liquid crystal layer 30, similar to the first alignment film 12. Materials for forming the first alignment film 12 are the above-described alignment film materials.

The pretilt angle given to the liquid crystal material of the liquid crystal layer 30 by the first alignment film 12 and the pretilt angle given to the liquid crystal material of the liquid crystal layer 30 by the second alignment film 22 may be the same as or different from each other.

The alignment direction of the liquid crystal material of the liquid crystal layer 30 due to the first alignment film 12 and the alignment direction of the liquid crystal material of the liquid crystal layer 30 due to the second alignment film 22 may be set to an anti-parallel alignment in a field of view from a normal direction to the one substrate 11 (a field of view when the one substrate 11 is viewed in a plan view). “Anti-parallel alignment” refers to azimuth angles of the liquid crystal materials being the same in the field of view when the one substrate 11 is viewed in a plan view.

Further, the liquid crystal display device 100 may include a sealing portion that is disposed between the one substrate 11 and the other substrate 21 and surrounds the periphery of the liquid crystal layer 30 or a spacer that is a columnar structure for defining a thickness of the liquid crystal layer 30.

### <Method of Manufacturing Liquid Crystal Display Device>

A method of manufacturing the liquid crystal display device 100 of the embodiment will be described. Hereinafter, a case in which the first alignment film 12 and the second alignment film 22 are formed of the same material will be described, but the present invention is not limited thereto.

First, a film of an alignment film material is formed on the pair of substrates (the one substrate 11 and the other substrate 21), and a photoalignment treatment is performed to form alignment films (the first alignment film 12 and the second alignment film 22). Subsequently, the pair of substrates are bonded together. A liquid crystal composition containing a liquid crystal material and a di(meth)acrylate monomer having a 4,4′-biphenylene group is injected between the bonded substrates in the pair to form the liquid crystal layer 30. Finally, the di(meth)acrylate monomer in the liquid crystal composition is photopolymerized to form the polymer layers (the first polymer layer 40 and the second polymer layer) by radiating ultraviolet radiation from the one substrate 11 while applying a voltage. Thus, the liquid crystal display device 100 is obtained.

In the method of manufacturing the liquid crystal display device 100 according to the embodiment, many monomers remain on the side opposite to the light irradiation surface, as compared with a method of manufacturing a liquid crystal display device according to the related art. Therefore, in the method of manufacturing the liquid crystal display device 100 according to the embodiment, it is preferable for an irradiation time of ultraviolet radiation to be lengthened as compared with the manufacturing method of the liquid crystal display device according to the related art in order to sufficiently polymerize the monomers on the side opposite to the light irradiation surface.

Although the embodiment of the present invention has been described above, the respective configurations, combinations thereof, and the like in the embodiment are merely examples, and additions, omissions, substitutions, and other changes to the configurations can be performed without departing from the spirit of the present invention. Further, the present invention is not limited by the embodiment.

### EXAMPLES

Hereinafter, the present invention will be described with reference to examples, but the present invention is not limited to these examples.

### [VHR Measurement]

For each obtained liquid crystal cell, a VHR was measured under conditions of 1 V, 60 Hz, and 70° C. using a 6254 type VHR meter manufactured by Toyo Corporation. Here, the VHR means the fraction of the charge charged during one frame period which is maintained.

A liquid crystal cell having a high VHR can be judged to be good. Further, a liquid crystal cell having a small decrease in VHR before and after a thermal stability test to be described below can be judged to have high thermal stability.

### [Pretilt Angle Measurement]

For the pair of substrates of each obtained liquid crystal cell, a pretilt angle was measured in an environment of 25° C. using an AxoScan manufactured by AXOMETRICS Inc. Here, the pretilt angle means an angle of the liquid crystal material with respect to the substrate in a state in which no voltage is applied.

### [Bend Transition Time]

When a voltage of 5 V was applied to each obtained liquid crystal cell, a state in which the liquid crystal material transitions from a splay alignment to a bend alignment was visually observed and a time required for the transition was measured.

### [Preparation of Liquid Crystal Cells (Examples 1-1 to 1-3)]

### (Preparation of Alignment Film Material)

SiO₄—AlO₄ was added as inorganic compound particles to a photoalignment film solvent (photoisomerization type) containing an acrylic resin. The amount of addition of the inorganic compound particles was 0% by mass (Example 1-1), 1% by mass (Example 1-2), 5% by mass (Example 1-3) based on the total mass of the acrylic resin. The resultant alignment film materials were left in a dark place for one week after the addition.

### (Preparation of Liquid Crystal Composition)

A positive type liquid crystal material (Tni: 85° C. Δn: 0.15, and Δε: 7.0) in which a total mass of the liquid crystal compound (L1) having a terphenyl group and the liquid crystal compound (L2) having a tetraphenyl group was 8% by mass of a total mass of the liquid crystal material was prepared. 0.5% by mass of a monomer (A1) with respect to a total mass of the liquid crystal composition was added to this liquid crystal material to obtain a liquid crystal composition. A ratio of the content of the liquid crystal compound (L1) to the liquid crystal compound (L2) was L1:L2=20:1 as a mass ratio.

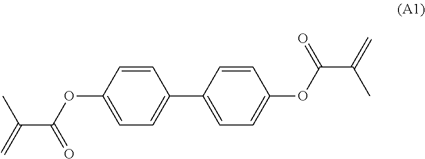 [SMILES: C=C(C)C(=O)Oc1ccc(-c2ccc(OC(=O)C(=C)C)cc2)cc1]

### (Preparation of Bend Alignment Cell)

A film of the alignment film material obtained in the above-described “Preparation of alignment film material” was formed on the pair of substrates and a photoalignment treatment was performed to obtain horizontal alignment. Subsequently, a pair of substrates were bonded together so that a thickness of the liquid crystal cell was 3 mm. Subsequently, the liquid crystal composition obtained in the above-described “Preparation of liquid crystal material” was injected between the bonded substrates in the pair to obtain a laminate. Finally, 4 J/cm² ultraviolet radiation (365 nm illuminance meter) was radiated to the laminate from one substrate side for two hours using an FHF32BLB available from Toshiba while applying an AC voltage of 10 V. Thus, a liquid crystal cell having a configuration as illustrated in FIG. 1 was prepared.

It should be noted that anti-parallel cells (cells obtained by forming a film of an alignment film material on a pair of substrates and performing photoalignment treatment so that alignment directions were different by 180° from each other) were also prepared under the same conditions for measurement of the pretilt angle.

### Example 1-4

Liquid crystal cells were prepared as in Example 1-3 except that 1% by mass of a monomer (A2) with respect to a total mass of the liquid crystal composition was added instead of the monomer (A1) in the “Preparation of the liquid crystal composition” described above.

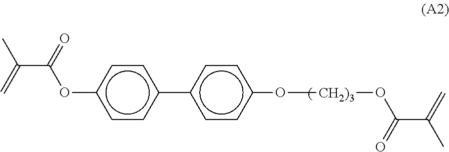

Each of the obtained liquid crystal cells was left in an oven at 70° C. for 500 hours, and a thermal stability test was performed. The VHR, the pretilt angle, and the bend transition time before and after the thermal stability test were measured. Results thereof are shown in Table 1. It should be noted that, in the example, since a sealing width of the pair of substrates is sufficiently large in each liquid crystal cell, an influence of humidity can be neglected.

TABLE 1

| | | | | Initail | | | | After 500 hours | | | |
|---|---|---|---|---|---|---|---|---|---|---|---|
| | | | | | | | Bend | | | | Bend |
| | Content of | Monomer | | Pretilt angle (deg.) | | | transition | Pretilt angle (deg.) | | | transition |
| | inorganic | | Content | One | Other | | time | One | Other | | time |
| | compound | Type | (%) | substrate | substrate | VHR (%) | (minutes) | substrate | substrate | VHR (%) | (minutes) |
| Example | 0.5 | A1 | 0 | 11.4 | 11.5 | 98.6 | <0.5 | 7.5 | 7.2 | 98.1 | 3 |
| 1-1 | | | | | | | | | | | |
| Example | 0.5 | A1 | 1 | 11.3 | 11.3 | 98.5 | <0.5 | 11.0 | 10.3 | 98.1 | 0.6 |
| 1-2 | | | | | | | | | | | |
| Example | 0.5 | A1 | 5 | 11.3 | 11.6 | 98.6 | <0.5 | 11.2 | 10.7 | 98.2 | <0.5 |
| 1-3 | | | | | | | | | | | |
| Example | 1.0 | A2 | 5 | 11.6 | 11.9 | 98.4 | <0.5 | 11.6 | 11.8 | 98.4 | <0.5 |
| 1-4 | | | | | | | | | | | |

As shown in Table 1, in the liquid crystal cells of Examples 1-1 to 1-4 in which the present invention was applied, a difference in pretilt angle between the two of the substrates before the thermal stability test became smaller. Further, in the liquid crystal cells of Examples 1-1 to 1-4, a decrease in pretilt angle was suppressed for both of the substrates between before and after the thermal stability test. As a result, in the liquid crystal cells of Examples 1-1 to 1-4, an increase in bend transition time became smaller. From these facts, it can be said that the liquid crystal cells of Examples 1-1 to 1-4 have long-term stability in a pretilt direction before and after the thermal stability test.

Further, in the liquid crystal cells of Examples 1-2 to 1-4 in which SiO₄—AlO₄ was added to the alignment film, the decrease in the pretilt angle before and after the thermal stability test became smaller as compared with the liquid crystal cell of Example 1-1 without addition of SiO₄—AlO₄. From this, it can be said that the thermal stability of the liquid crystal cells of Examples 1-2 to 1-4 was improved as compared with Example 1-1.

Further, the pretilt angles of the liquid crystal cells of Examples 1-2 to 1-4 were stabilized as described above, and as a result, the increase in bend transition time became smaller as compared with Example 1-1. From this, it can be said that the liquid crystal cells of Examples 1-2 to 1-4 have long-term stability in the pretilt direction as compared with Example 1-1.

Further, in Example 1-4, the solubility of the monomer in the liquid crystal composition was improved by using the monomer (A2) obtained by introducing an alkylene group into the monomer (A1). The concentration of the monomer in the liquid crystal composition was increased, and as a result, the amount of change in the pretilt angle before and after the thermal stability test became smaller as compared with Examples 1-2 and 1-3. From this, it can be said that the thermal stability of the liquid crystal cell in Example 1-4 was further improved as compared with Examples 1-2 and 1-3.

It is presumed that a reason for this is that the thickness of the polymer layer was increased as a result of the improvement of the concentration of the monomer in the liquid crystal composition. It is also presumed that another reason is that the polymer layer was formed on the alignment film surface so that exposure of the alignment film was further reduced (that is, direct contact between the alignment film and the liquid crystal layer was reduced).

### [Preparation of Liquid Crystal Cell (Reference Examples 1 to 3, and Example 2-1)]

A liquid crystal cell was prepared as in Example 1-3 except that the irradiation time was changed to 0.5 to 2 hours at 0.5 hour intervals in the “Preparation of bend alignment cell” described above.

Each obtained liquid crystal cell was left for 100 hours in an oven at 70° C., and a thermal stability test was performed. The VHR, the pretilt angle, and the bend transition time before and after the thermal stability test were measured. Results thereof are shown in Table 2.

TABLE 2

| | | | | | | After 500 hours | | | |
|---|---|---|---|---|---|---|---|---|---|
| | | Initail | | | | | | | Bend |
| | | Pretilt angle (deg.) | | | Bend | Pretilt angle (deg.) | | | transition |
| | Irradiation | | Other | | transition time | | Other | | time |
| | time (hours) | One substrate | substrate | VHR (%) | (minutes) | One substrate | substrate | VHR (%) | (minutes) |
| Reference | 0.5 | 10.7 | 9.6 | 97.5 | 0.7 | 11.3 | 11.6 | 97.3 | 0.5 |
| example 1 | | | | | | | | | |
| Reference | 1 | 11.0 | 10.1 | 98.1 | 0.6 | 11.5 | 11.5 | 97.6 | 0.5 |
| example 2 | | | | | | | | | |
| Reference | 1.5 | 11.3 | 11.6 | 98.2 | <0.5 | 11.7 | 11.6 | 97.6 | <0.5 |
| example 3 | | | | | | | | | |
| Example 2-1 | 2 | 11.4 | 11.5 | 98.6 | <0.5 | 11.6 | 11.7 | 98.5 | <0.5 |

In the “Preparation of bend alignment cell” described above, the amount of change in the pretilt angle before and after the thermal stability test became smaller and the change in the bend transition time also became smaller as an irradiation time of ultraviolet light increased, as shown in Table 2. From this, it can be said that the long-term stability in the pretilt direction in the liquid crystal display device is improved as the irradiation time of the ultraviolet light increases.

Further, an initial VHR was lower as the irradiation time of the ultraviolet light decreased. From this, it can be said that the liquid crystal display device with high reliability can be obtained as the irradiation time of the ultraviolet light increases. It was confirmed from the above that the irradiation time may be set to be equal to or greater than about 2 hours in order to obtain a liquid crystal display device having long-term stability in the pretilt direction and high reliability.

### [Preparation of Liquid Crystal Cell (Example 3-1 and Comparative Examples 3-1 and 3-2)]

A liquid crystal cell was prepared as in Example 1-3 except that 0.5% by mass of a monomer (A1), a monomer (B1), and a monomer (C1) was added as monomers to be used to the total mass of the liquid crystal composition in the “Preparation of liquid crystal composition” described above.

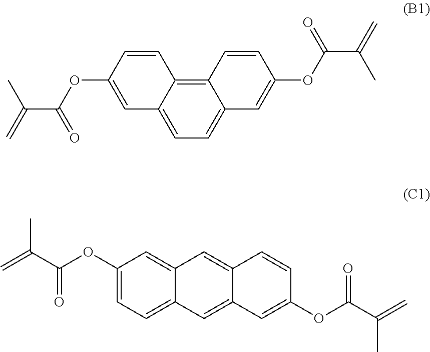

Each resultant liquid crystal cell was left in an oven at 70° C. for 100 hours, and a thermal stability test was performed. The VHR, the pretilt angle, and the bend transition time before and after the thermal stability test were measured. Results thereof are shown in Table 3.

TABLE 3

| | | | Initail | | | | After 500 hours | | | |
|---|---|---|---|---|---|---|---|---|---|---|
| | | | | | | Bend | | | | Bend |
| | | | Pretilt angle (deg.) | | | transition | Pretilt angle (deg.) | | | transition |
| | Monomer | | One | Other | | time | One | Other | | time |
| | Type | Content (%) | substrate | substrate | VHR (%) | (minutes) | substrate | substrate | VHR (%) | (minutes) |
| Example 3-1 | A1 | 0.5 | 11.4 | 11.5 | 98.6 | <0.5 | 11.6 | 11.7 | 98.5 | <0.5 |
| Comparative | B1 | 0.5 | 10.1 | 8.2 | 98.5 | 1 | 10.6 | 8.8 | 98.3 | 0.9 |
| example 3-1 | | | | | | | | | | |
| Comparative | C1 | 0.5 | 11.5 | 9.2 | 98.3 | 1.3 | 11.6 | 9.7 | 98.0 | 1 |
| example 3-2 | | | | | | | | | | |

As shown in Table 3, in the liquid crystal cell of Example 3-1 in which the present invention was applied, a difference in the pretilt angle became smaller between the one substrate and the other substrate, as compared with liquid crystal cells of Comparative Examples 3-1 and 3-2. As a result, in the liquid crystal cell of Example 3-1, an increase in bend transition time became smaller before and after the thermal stability test. From this, it can be said that the liquid crystal cell of Example 3-1 has long-term stability in the pretilt direction.

Reasons for this are presumed as follows. The monomer (A1) used in Example 3-1 has a 4,4′-biphenylene group. The 4,4′-biphenylene group can be considered to have a high affinity with the acrylic resin contained in the alignment film, as compared with a phenanthrene group contained in the monomer (B1) used in Comparative Example 3-1 or an anthracene group contained in the monomer (C1) used in Comparative Example 3-2. Therefore, it can be considered that the monomer (A1) was distributed in the vicinity of the surface of each of the two alignment films. As a result, it can be considered that the polymer layer was uniformly formed on both of the one substrate side and the other substrate side. Thus, in the liquid crystal cell of Example 3-1, it is presumed that the difference in the pretilt angle between the one substrate and the other substrate became smaller.

It was shown from the above results that the present invention is useful.

### DESCRIPTION OF THE REFERENCE SYMBOLS

11 One substrate
12 First alignment film
21 Other substrate
22 Second alignment film
30 Liquid crystal layer
40 First polymer layer
50 Second polymer layer
100 Liquid crystal display device

1. A liquid crystal display device comprising:
a pair of substrates;
a liquid crystal layer sandwiched between the pair of substrates;
alignment films disposed between the liquid crystal layer and the pair of substrates; and
polymer layers disposed between the alignment films and the liquid crystal layer,
wherein a material for forming the liquid crystal layer is a liquid crystal material,
the liquid crystal material contains a liquid crystal compound having a polyphenylene group,
a material for forming the alignment film is an alignment film material containing an acrylic resin having a photoreactive functional group, and
the polymer layer is a polymer of a (meth)acrylate monomer containing an aryl group having no condensed ring structure.

2. The liquid crystal display device according to claim 1, wherein the liquid crystal compound contains at least one of a liquid crystal compound (L1) having a terphenyl group and a liquid crystal compound (L2) having a tetraphenyl group.

3. The liquid crystal display device according to claim 2, wherein the liquid crystal compound contains both a liquid crystal compound (L1) having a terphenyl group and a liquid crystal compound (L2) having a tetraphenyl group.

4. The liquid crystal display device according to claim 3, wherein a total content of the liquid crystal compound (L1) and the liquid crystal compound (L2) relative to a total mass of the liquid crystal material is 3% by mass or more and 15% by mass or less.

5. The liquid crystal display device according to claim 1, wherein the polymer layer is a polymer of a di(meth)acrylate monomer having a 4,4′-biphenylene group.

6. The liquid crystal display device according to claim 1,
wherein the alignment film material contains inorganic compound particles expressed by a general equation SiOₓ—AlOₓ (x is an integer from 1 to 12), and
a content of the inorganic compound particles relative to a total mass of the acrylic resin is greater than 0% by mass and smaller than 7% by mass.

7. The liquid crystal display device according to claim 6, wherein the inorganic compound particles are expressed by a general equation SiO₄—AlO₄.
